(19) United States
(12) Patent Application Publication
(10) Pub. No.: US 2010/0183387 A1
(43) Pub. Date: Jul. 22, 2010

(54) ADJUSTABLE DRILLING EDGE-WIDENING AND SCREW DRIVING TOOL SET

(76) Inventor: HO-TIEN CHEN, Tainan (TW)

Correspondence Address: J C PATENTS, 4 VENTURE, SUITE 250, IRVINE, CA, 92618, US

(21) Appl. No.: 12/355,994

(22) Filed: Jan. 19, 2009

(51) Int. Cl. B23B 51/08

(52) U.S. Cl. 408/26

(57) ABSTRACT

An adjustable drilling edge-widening and screw driving tool set includes a main body, a first sleeve, a second sleeve and a third sleeve. The main body has the front portion installed with a drill base and the rear portion combined with a locking rod of a powered tool. With the powered tool to drive the main body to rotate, the drill base fixing a drill can be simultaneously driven to rotate. A first sleeve combined with a second sleeve is used to operate a micro adjustment of extending length of the drill base and the drill to get a precise depth of drilling and edge-widening, and a third sleeve is employed to enable the locking rod combined with or released from the rear portion of main body. The locking rod released from the main body can be solely used as a screw driver. So, the adjustable tool set has three kinds of functions.

### BACKGROUND OF THE INVENTION

1. Field of the Invention

This invention relates to an adjustable drilling edge-widening and screw driving tool set, particularly to one provided with a main body installed with a drill base in the front portion and combined with a locking rod of a powered tool in the rear portion. With the powered tool to drive the main body to rotate, the drill base fixing a drill can be simultaneously driven to rotate. A first sleeve combined with a second sleeve is used to operate a micro adjustment of extending length of the drill base and the drill so as to get a precise depth of drilling and edge-widening, and a third sleeve is employed to enable the locking rod of the powered tool combined in or released from the rear portion of main body. So, the adjustable drilling edge-widening and screw driving tool set of this invention has three kinds of functions, drilling, edge-widening and screw driving.

2. Description of the Prior Art

Commonly, a conventional adjustable drilling edge-widening tool set includes a main body 1 provided with a center hole 10 for accommodating a drill base 11 that is fixed with the main body 1 by means of a screwing member 110, which can be also utilized to adjust the extending length of the drill base 11. The drill base 11 is further provided with a center hole 111 for accommodating a drill 12 that is fixed with the drill base 12 by means of a screwing member 112, which can be also utilized to adjust the extending length of the drill 12. Then, a sleeve 13 is mounted around a front portion of the main body 1.

However, a user cannot precisely achieve the extending length of the drill base 11 and the drill 12 by respectively controlling the screwing members 110 and 112, causing inconvenient usage. Moreover, the conventional adjustable drilling edge-widening tool set can do no more than drilling and edge-widening, too less functions.

### SUMMARY OF THE INVENTION

The object of this invention is to offer an adjustable drilling edge-widening and screw driving tool set with three functions, so that a user can drill a hole in an object, edge-widen around an opening of the drilled hole, and drive a screw by a locking rod connected with a powered tool, without using different tools.

The main characteristics of the invention are a main body, a first sleeve, a second sleeve and a third sleeve.

The main body is provided with a center hole having the front portion installed with a drill base and the rear inner wall formed polygonal for combining with a locking rod of a powered tool to drive the main body to rotate. The drill base fixes a drill to drill a hole in an object and has a knife blade formed on the front side to edge-widen the opening of the hole drilled by the drill. Finally, the locking rod driven by the powered tool can be utilized to drive a screw.

The first sleeve is adjustably combined with the main body to change its position to the main body, so as to micro-adjust the drill relative to the drill base.

The second sleeve is installed around the main body at the front of the first sleeve, able to be adjusted in its extending length by the micro adjustment of the first sleeve, so that the drill base may be adjusted in its extending length, and thus the depth of drilling and edge-widening can be decided.

The third sleeve is installed around the rear portion of the main body, provided with a curved slot able to let a second position steel ball of the main body move inside it by rotating the third sleeve, enabling the locking rod of the powered tool fixed in or released from the rear portion of the main body.

### BRIEF DESCRIPTION OF DRAWINGS

This invention is better understood by referring to the accompanying drawings, wherein:

FIG. 1 is a cross-sectional view of a conventional adjustable drilling edge-widening tool set;

FIG. 2 is a cross-sectional view of a preferred embodiment of an adjustable drilling edge-widening and screw driving tool set in the present invention;

FIG. 3 is a cross-sectional view of the preferred embodiment of an adjustable drilling edge-widening and screw driving tool set in the present invention, showing it being adjusted;

FIG. 4 is a side cross-sectional view of a main body in the present invention;

FIG. 5 is a cross-sectional view of the “A-A” line in FIG. 4;

FIG. 6 is a side cross-sectional view of a first sleeve in the present invention;

FIG. 7 is a cross-sectional view of the “B-B” line in FIG. 6;

FIG. 8 is a cross-sectional view of the invention and a locking rod of a powered tool, showing they are to be combined together;

FIG. 9 is a cross-sectional view of a third sleeve and a second position steel ball, showing their relative positions before the combination of the invention and the locking rod of the powered tool;

FIG. 10 is a cross-sectional view of the invention and the locking rod of the powered tool, showing they are combined together; and

FIG. 11 is a cross-sectional view of the third sleeve and the second position steel ball, showing their relative positions after the combination of the invention and the locking rod of the powered tool.

### DETAILED DESCRIPTION OF THE PREFERRED EMBODIMENT

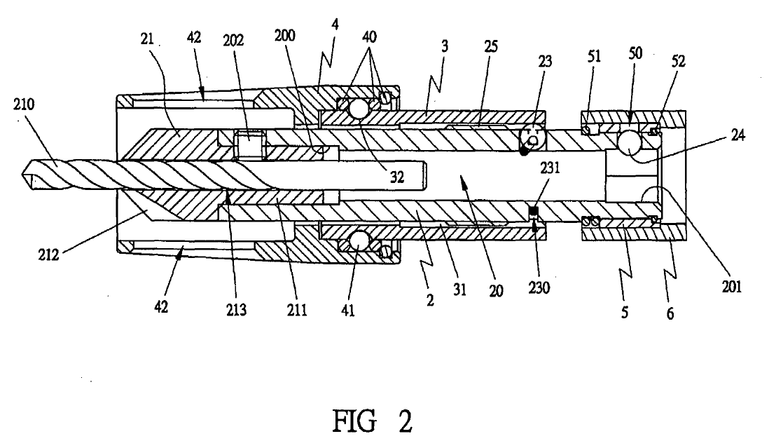

As shown in FIGS. 2˜5, a preferred embodiment of an adjustable drilling edge-widening and screw driving tool set in the present invention includes a main body 2, a first sleeve 3, a second sleeve 4, a third sleeve 5 and an annular cap 6.

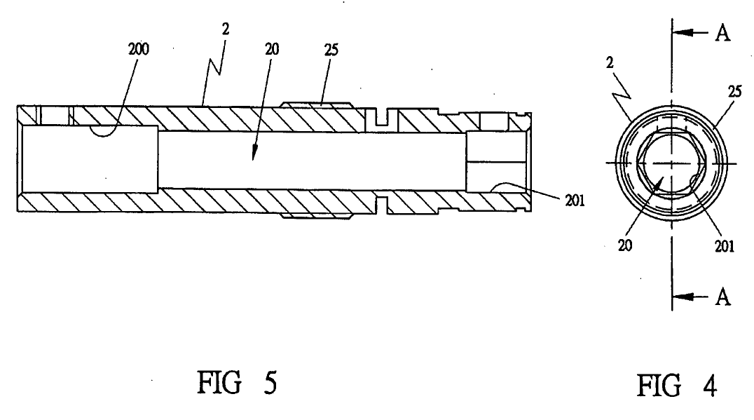

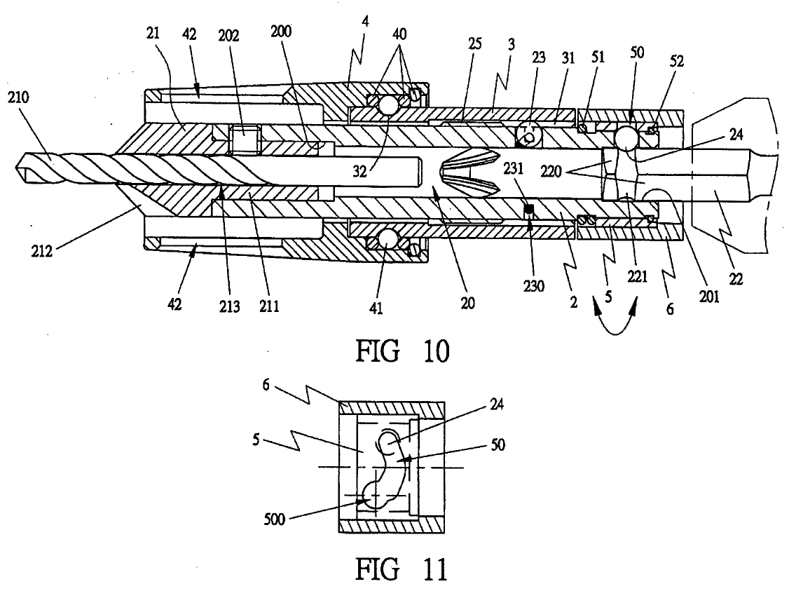

The main body 2 is provided with a center hole 20, which possesses a large inner annular circumference 200 formed in the front portion to accommodate a drill base 21 and a polygonal circumference 201 (shown in FIGS. 4 and 5) formed in the rear inner wall for combining with a locking rod 22 (shown in FIG. 10) of a powered tool so as to drive the main body 2 to rotate. The polygonal circumference 201 is formed as a geometric shape except a circle, identical to that of the locking rod 22 of the powered tool. The center hole 20 is also provided with a screwing member 202 utilized to keep the drill base 21 fixed with a drill 210 so as to adjust the extending length of the drill 210. The main body 2 is further provided with a first position steel ball 23 used for restricting the first sleeve 3, a second position steel ball 24 used for restricting the third sleeve 5, male threads 25 formed in the exterior wall, and an annular slot 230 formed at one side of the first position steel ball 23 for accommodating an O-shaped ring 231.

Furthermore, the drill base 21 is provided with a rod 211, plural knife blades 212 and a center hole 213. The rod 211 is installed in the inner annular circumference 200 of the center hole 20, and fixed with the main body 2 by means of the screwing member 202. The knife blades 212 are integrally formed spaced apart on the front of the drill base 21, so as to enable the drill 210 to conveniently extend in the center hole 213 and positioned by the screwing member 202 to adjust its extending length for controlling how deep the drill 210 is to go.

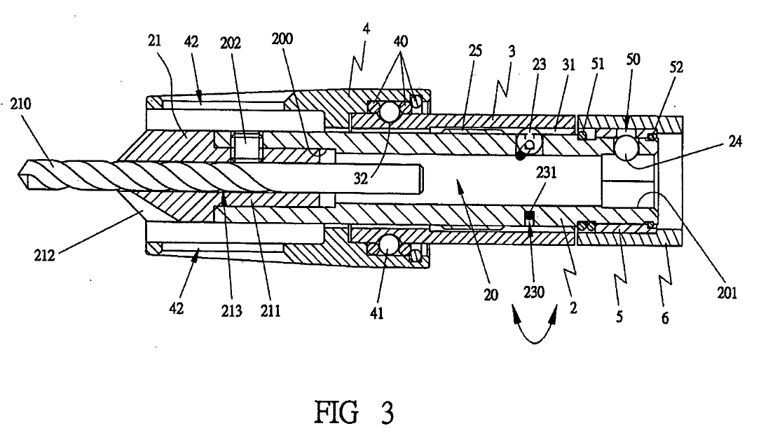

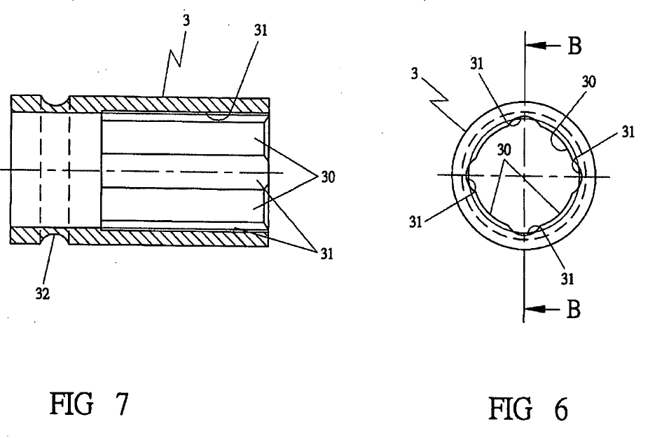

The first sleeve 3, as shown in FIGS. 2, 3, 6 and 7, is provided with female threads 30 formed in the inner wall for engaging with the male threads 25 of the main body 2 to combine the first sleeve 3 together with the main body 2. The first sleeve 3 is further provided with plural grooves 31 formed in the inner wall to correspondingly work with the first position steel ball 23 to achieve a positioning purpose, and an annular concave circumference 32 formed in the front portion.

The second sleeve 4 is mounted around the front portion of the first sleeve 3, provided with plural C-shaped constrict rings 40, and plural steel balls 41, each of which is stabilized by a certain number of the C-shaped constrict rings 40. The steel balls 41 are fitted in the annular concave circumference 32 so that the second sleeve 4 is positioned at the front of the first sleeve 3. That is, with C-shaped constrict rings 40 combined with the steel balls 41 to function like bearings, friction can be lowered between the first sleeve 3 and the second sleeve 4 and furthermore, the size of the first sleeve 3 and the second sleeve 4 can be shrunk to cut down the size of the whole tool set of the invention for easy operation. Of course, if size is not needed to be considered, a ball bearing can be instead utilized. The second sleeve 4 is further provided with an opening 42 employed for a user to conveniently operate the screwing member 202 to adjust a macro extending length of the drill 210 by a hand tool and to enable bits cut during drilling of the drill 210 to be swiftly exhausted from it.

When the first sleeve 3 is rotated, it can be moved forward or backward to simultaneously change the position of the first sleeve 3 and the second sleeve 4 combined with the main body 2; that is, with no necessity to adjust the screwing member 202 by any hand tool, a user can precisely adjust a micro extending length of the drill base 21 and the drill 210 by means of the first position steel ball 23 of the main body 2 properly combined with the grooves 31 of the first sleeve 3. In other words, when the first sleeve 3 is whirled with a proper circumferential distance to enable the first position steel ball 23 to enter one of the grooves 31 of the first sleeve 3, a user can accordingly realize how far the drill base 21 and the drill 210 have extended forward and backward to achieve a precise micro adjustment, so that the drilling depth of the drill 210 and the edge-widening depth of the knife 212 can be undoubtedly decided. Moreover, with the buffering elasticity of the O-shaped constrict ring 231, the first position steel ball 23 can silently enter any of the grooves 31 of the first sleeve 3 and be tightly contacted with the O-shaped constrict ring 231 to be fixedly positioned in the groove 31 after having the locking rod 22 combined with the main body 2. By the time, the first sleeve 3 is completely positioned to ensure that the depth to be drilled or edge-widened is not to be altered while the tool set of the invention is driven to rotate by the locking rod 22.

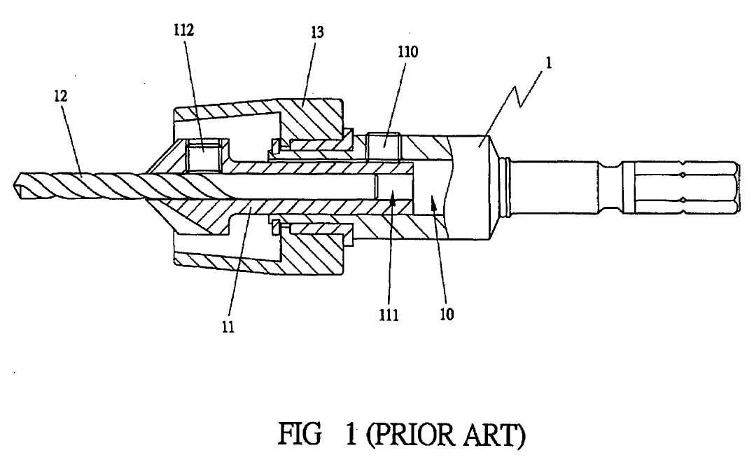

The third sleeve 5, as shown in FIGS. 1, 2, 8, 9 and 10, is installed around the rear side of the main body 2, provided with a curved slot 50 having a larger opening 500 at one side. The third sleeve 5 is first constricted inside the annular cap 6 and then, installed on the rear side of the main body 2, with an elastic device 51 previously installed between the third sleeve 5 and the main body 2. And, a C-shaped constrict ring 52 is successively used to lock the rear inside of the third sleeve 5 and the rear outside of the main body 2, enabling the third sleeve 5 and the main body 2 combined together.

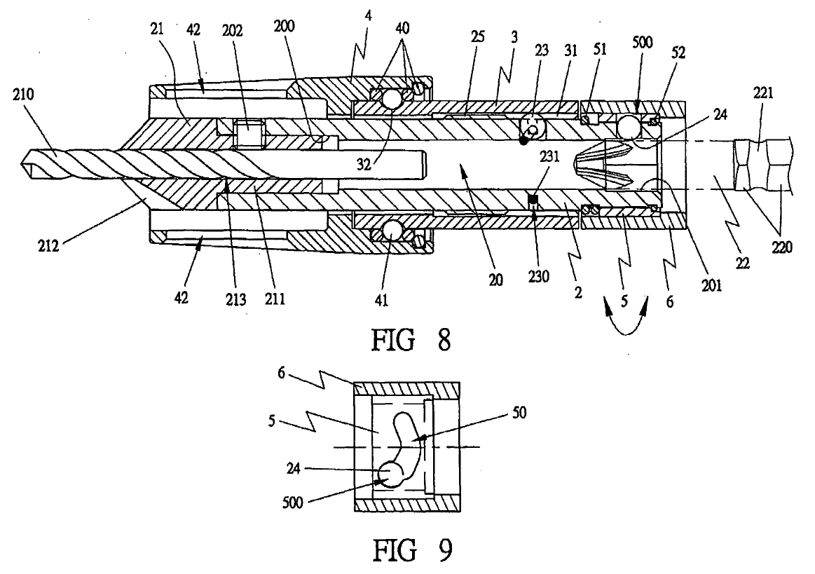

The second position steel ball 24 of the main body 2 is employed to relatively function with the curved slot 50 of the third sleeve 5, so as to enable the locking rod 22 to engage with or disengage from the main body 2. By rotating the third sleeve 5 and the annular cap 6, the second position steel ball 24 can be allowed to move inside the curved slot 50 (actually, it's the curved slot 50 moving to accept the second position steel ball 24). FIG. 9 shows the second position steel ball 24 positions just in front of the opening 500 of the curved slot 50. FIG. 8 shows the second position steel ball 24 moves into the opening 500 to freely run up and down. By the time, the locking rod 22 of the powered tool can smoothly pass into the center hole 20 of the main body 2 to keep a polygonal rod 220 engaged with the polygonal circumference 201 of the main body 2 because the second position steel ball 24 is not blocking. Then, after the second position steel ball 24 is fitted in a steel ball groove 221 of the locking rod 22, a user can rotate the third sleeve 5 and the annular cap 6 to move the second position steel ball 24 away from the opening 500 of the curved slot 50, as shown in FIGS. 10 and 11. With the locking rod 22 absolutely fixed with the main body 2, a powered tool can thus drive the main body 2 to whirl around so that the drill 210 can simultaneously rotate to drill in an object and the knife 212 of the drill base 21 can edge-widen the opening of a hole drilled by the drill 210.

After drilling and edge-widening, the third sleeve 5 and the annular cap 6 just need to be reversely rotated to let the second position steel ball 24 enter the opening 500 of the curved slot 50 to move along. By the time, without being blocked by the second position steel ball 24, the locking rod 22 can be smoothly pulled out of the main body 2. Then, the locking rod 22 driven by the powered tool can be solely utilized as a screw driver.

Therefore, the tool set of the invention can do drilling, edge-widening and screw driving, with a depth of drilling and edge-widening precisely adjusted every time, being a real practical tool set.

While the preferred embodiment of the invention has been described above, it will be recognized and understood that various modifications may be made therein and the appended claims are intended to cover all such modifications that may fall within the spirit and scope of the invention.

What is claimed is:

1. An adjustable drilling edge-widening and screw driving tool set comprising:
a main body provided with a center hole installed with a drill base in a front wall, a polygonal circumference formed in a rear portion of said center hole for combining with a locking rod of a powered tool, a screwing member utilized to keep said drill base fixed with a drill so as to thereof adjust an extending length of said drill base and said drill, said main body further provided with a first position steel ball for combining with a first sleeve, and a second position steel ball employed for combining with a third sleeve;
said first sleeve combined with said main body and able to freely alter its position combined with said main body so as to adjust a micro extending length of said drill base and said drill, plural grooves formed in an inner wall of said first sleeve for said first position steel ball to optionally fit in to adjust a position of said drill base and said drill every time;
said second sleeve installed around a front portion of said first sleeve and stabilized there by plural C-shaped constrict rings combined with plural steel balls so as to function like a ball bearing and possible to be adjusted in its extending length by a micro adjustment of said first sleeve so that said drill base and said drill may be adjusted in their extending length to decide a depth of drilling and edge-widening; and
said second sleeve installed around a front portion of said first sleeve and stabilized there by plural C-shaped constrict rings combined with plural steel balls so as to function like a ball bearing and able to be adjusted in its extending length by a micro adjustment of said first sleeve so that said drill base and said drill are adjusted in their extending length to decide a depth of drilling and edge-widening.

2. The adjustable drilling edge-widening and screw driving tool set as claimed in claim 1, wherein said main body is provided with an annular slot formed at one side of said first position steel ball for accommodating an O-shaped ring.

3. The adjustable drilling edge-widening and screw driving tool set as claimed in claim 1, wherein said center hole of said main body is provided with a polygonal circumference formed in a rear inner wall.

4. The adjustable drilling edge-widening and screw driving tool set as claimed in claim 1, wherein said drill base includes a rod installed in an inner annular circumference of said center hole and fixed with said main body by means of a screwing member, a knife formed on a front of said drill base and provided with plural petals so as to enable said drill to conveniently extend in said center hole and positioned by a screwing member to adjust its extending length for controlling how deep said drill is to go.

5. The adjustable drilling edge-widening and screw driving tool set as claimed in claim 1, wherein said C-shaped constrict rings combined with said steel ball are installed between said first sleeve and said second sleeve, said steel balls fitted in an annular concave circumference of said first sleeve so as to enable said second sleeve stabilized at a front portion of said first sleeve.

6. The adjustable drilling edge-widening and screw driving tool set as claimed in claim 5, wherein said second sleeve is further provided with an opening employed for a user to conveniently operate said screwing member of said main body to adjust a macro extending length of said drill by a hand tool and bits cut during drilling of said drill to be swiftly exhausted out.

7. The adjustable drilling edge-widening and screw driving tool set as claimed in claim 1, wherein said main body is further provided with a O-shaped constrict ring employed to provide elastic buffer as said first position steel ball enters any of said grooves of said first sleeve and tightly contact said first position steel ball after having said locking rod combined with said main body so that said first position steel ball is positioned in said groove to enable said first sleeve absolutely stabilized there.

8. The adjustable drilling edge-widening and screw driving tool set as claimed in claim 1, wherein an elastic device is previously installed between said third sleeve and said main body before said third sleeve is installed around a rear side of said main body and a C-shaped constrict ring is then used to lock a rear inside of said third sleeve and a rear outside of said main body to enable said third sleeve and said main body 2 combined together.
